(19) United States
(12) Patent Application Publication
(10) Pub. No.: US 2007/0100052 A1
(43) Pub. Date: May 3, 2007

(54) Clay modeling composition

(75) Inventors: Tak Kai Terry Lee, Hong Kong (HK); Huimin Wang, Hong Kong (HK)

Correspondence Address: WOOD, PHILLIPS, KATZ, CLARK & MORTIMER, 500 W. MADISON STREET, SUITE 3800, CHICAGO, IL, 60661, US

(73) Assignee: Lai on Products Industrial, Ltd.

(21) Appl. No.: 11/262,075

(22) Filed: Oct. 27, 2005

(51) Int. Cl. C08K 3/34

(52) U.S. Cl. 524/451; 524/487

(57) ABSTRACT

Floating clay modeling compositions which are light weight and a have increased resistance to cracking, flaking, and crumbling, which also are relative soft and easily molded at room temperature are provided. In one embodiment, the modeling composition consists of Microcrystalline wax (20-50 wt %), Synthetic wax (5-30 wt %), Ozokerite wax or Bee wax (1-20 wt %) or Elasto/Icing-wax (15-40 wt %), Polymer modified wax and/or polymer resin (0-30 wt %), oil (5-35 wt %), filler such as Talc powders (0-30 wt %) and Encapsulated copolymers (1-10 wt %). The modeling compositions can be used as clay for children.

### FIELD OF THE INVENTION

This invention relates to clay compositions, and in more particular applications, to modeling compositions for children.

### BACKGROUND OF THE INVENTION

The present invention is directed to light weight clay, which is also called floating clay wherein the density is less than 1. Light weight clay is distinguishable from heavier clays that have densities greater than 1.

Light weight clay modeling compositions typically include water-based play dough and oil-based clay. Water-based play doughs are normally air-dryable and incorporate starch as filler. Additionally, water-based light weight play doughs combine water soluble resin such as Poly Vinyl Alcohol (PVA) and light weigh fillers. This type of light weight clay tends to dry after modeling if left out overnight and thus the clay cannot be reshaped.

Non-water-based light weight clays include thermoplastic modeling compositions and wax/oil-based modeling compositions. The thermoplastic modeling compositions are generally used for producing design models in the automobile industry, such as described in U.S. Pat. No. 3,607,332. The modeling compositions are usually comprised of plastic, minerals, binders, light fillers, and color agents, which can be processed above 50° C. The shapes formed using this composition become rigid and much harder as the ambient temperature drops. However, these compositions, as used in industrial applications, have no final aggregate state and cannot be kneaded and/or modeled at room temperature and are therefore not suitable as clay for children.

Moreover, U.S. Pat. No. 6,837,924 describes a wax/oil based light weight modeling composition which consists of solid wax, pasty wax, oil base and light hollow microbead filler. Microbeads are monosized polymer particles which are mainly composed of two different classes of polymers such as polystyrene and polyacrylics having varying degrees of crosslinking. The polymer particles have a perfect spherical shape, are highly monosized and are made within a wide particle size range: 0.5-500 micron. Therefore, this kind of clay has a light-weight behavior. This composition can be kneaded and processed at room temperature for use by children. In addition, these compositions remains elastic and do not tend to cure. However, compositions made with pasty wax are too sensitive to temperature changes, especially at room temperature, because this is usually around the melting point of pasty wax. If the dough/clay is made with pasty wax/Vaseline suitable for use in countries with a colder climate, it is not suitable for use in countries with hot climates because it becomes too sticky. If the dough/clay is made with pasty wax/Vaseline suitable for use in countries with hot climate, it has a limitation to the countries with frigid climate since it becomes harder and more rigid in frigid climate. Additionally, paraffin oil is not good for children.

### SUMMARY OF THE INVENTION

In accordance with one feature of the invention, a modeling composition is provided. The modeling composition includes a solid wax, oil, fillers, 0-30 wt. % polymer resin and 1-10 wt. % microspheres. The microspheres include spherical polymer shells encapsulating a small amount of hydrocarbon.

According to one feature, the small amount of hydrocarbon increases its pressure and results in a dramatic expansion of the spheres when heated during manufacturing.

According to one feature, the solid wax comprises 20-50 wt. % microcrystalline wax, 5-30 wt. % synthetic wax, 1-20 wt. % ozokerite wax and 1-10 wt. % polymer modified wax.

According to one feature, the solid wax comprises 20-50 wt. % microcrystalline wax, 5-30 wt. % synthetic wax, 1-20 wt. % bee wax and 1-10 wt. % polymer modified wax.

According to one feature, the solid wax comprises 20-50 wt. % microcrystalline wax, 5-30 wt. % synthetic wax, 1-20 wt. % elasto/icing-wax and 1-10 wt. % polymer modified wax.

According to one feature, the filler includes talc powder.

According to one feature, the talc powder is at least one of 300-1000 mesh, 1000-2000 mesh, above 2000 mesh, or a mixture thereof.

In accordance with one feature, the modeling composition further comprises preservatives.

According to one feature, the preservatives include at least one of methylparaben, ethylparaben, propylparaben, and phenoxyethanol.

According to one feature, the modeling composition further comprises pigments.

According to one feature, the microspheres increase in size as the gas is heated.

According to one feature, the polymer resin includes at least one of polyurethane, polysiloxane and elastomers.

Other objects, advantages, and features will become apparent from a complete review of the entire specification, including the appended claims and drawings.

### DETAILED DESCRIPTION OF THE PREFERRED EMBODIMENTS

While the present invention is susceptible of embodiment in many different forms, there is shown in the drawing and will be described herein in detail specific embodiments thereof with the understanding that the present disclosure is to be considered as an exemplification of the principles of the invention and is not intended to limit the invention to the specific embodiments illustrated.

According to one aspect, the lightweight modeling composition has excellent resistance to freezing at −20° C. for 72 hrs and thermal cycling from −10 to 40° C. for 7 days. The lightweight modeling composition also has a soft and flexible texture.

In one embodiment, the modeling compositions consists of Microcrystalline wax (20-50 wt%), Synthetic wax (5-30 wt %), Ozokerite wax or Bee wax (1-20 wt %) or Elasto/Icing-wax (15-40 wt %), Polymer modified wax and/or polymer resin (0-30 wt %), oil (5-35 wt %), filler such as Talc powders (0-30 wt %) and microspheres (1-10 wt %) as well as various pigments and preservatives.

Encapsulated copolymers or microspheres, such as made under the name of Expancel®, are completely different materials from hollow microbeads, each with different microstructures and functions. For example, the microspheres have a polymer shell encapsulating a gas which is quite different from hollow microbeads used in other commercial clay products. When the gas inside the shell is heated, it increases its pressure and the thermoplastic shell softens, resulting in a dramatic increase in the volume of the microspheres. When fully expanded, the volume of the microspheres increases more than 40 times. Microbeads, however, are monosized polymer particles, which are mainly composed of two different classes of polymers like polystyrene and polyacrylics having varying degrees of crosslinking. The polymer particles have a perfect spherical shape, are highly monosized and are made within a wide particle size range, such as 0.5-500 micron. Microbeads do not function the same as microspheres.

One example of microspheres or encapsulated copolymers that can be used include EXPANCEL® DE (Akzo Nobel) products series products with the density range of 20-70 KG/m³, such as EXPANCEL 051, EXPANCEL 091, EXPANCEL 461, EXPANCEL 551, etc.

### EXAMPLE 1

TABLE 1

| | Percentage | Perfected |
|---|---|---|
| Ingredient | range by weight % | range by weight % |
| Microcrystalline wax | 30-50 | 38-42 |
| Synthetic wax | 10-30 | 18-22 |
| Ozokerite wax | 1-20 | 8-12 |
| Polymer modified wax | 1-10 | 3-6 |
| Mineral oil | 15-35 | 20-25 |
| Talc powders | 1-15 | 7-10 |
| Microspheres | 1-10 | 2-5 |
| Pigment | 0.1-20 | 0.2-16 |
| Preservative | 0.02-0.2 | 0.08-0.13 |

As shown in table 1, the modeling composition consists of Microcrystalline wax (30-50 wt %), Synthetic wax (10-30 wt %), Ozokerite wax (1-20 wt %), Polymer modified wax and (1-10 wt %), oil (15-35 wt %), Talc powders (1-15 wt %) and microspheres (1-10 wt %) as well as various pigments (0.1-20 wt %) and preservatives (0.02-0.2 wt %). In a preferred embodiment, the range is Microcrystalline wax (38-42 wt %), Synthetic wax (18-22 wt %), Ozokerite wax (8-12 wt %), Polymer modified wax and (3-6 wt %), oil (20-25 wt %), Talc powders (7-10 wt %) and microspheres (2-5 wt %).

Other components that may be included in the composition includes pigments. Such pigments include regular pigments, Neon pigments and pearl pigments as well as their mixtures. For example, the regular pigments are Ultramarine Blue, FD&C Yellow 5 Aluminum Lake, FD&C Red 40 Aluminum Lake, FD&C Yellow 6 Aluminum Lake, FD&C Blue 1 Aluminum Lake, Titanium Dioxide, D&C red 7 Calcium Lake, TG-601 Gold, K-100 Black or their blends. The content range of the regular pigments is from 0.1 to 5 % by weight. In one embodiment, the preferred range is 0.3 to 3 %by weight. The Neon pigments such as Sterling Florescent Red 3, Sterling Florescent Blue 60, Sterling Florescent Yellow 27, Sterling Florescent Strong Magenta 21, Sterling Florescent Orange 5, Sterling Florescent Green 8 or their blends have a content range of 0.1 to 3 % by weight. In one embodiment, the preferred range is 0.5 to 2 % by weight. The pearl pigments include 5500 Timica silver sparkle, 1500 Timica extra bright, 110A Timica pearl white as well as their blends with regular or Neon pigments etc. The content range is from 5 to 20 % by weight. In one embodiment, the preferred range is 10 to 15 % by weight. Preservatives with the pH values of 3 to 10 are suitable for use in the modeling composition. For example, the preservative used in example 1 is from the paraben series such as Propylparaben and Methylparaben.

### Example 2

TABLE 2

| | Percentage | Perfected |
|---|---|---|
| Ingredient | range by weight % | range by weight % |
| Microcrystalline wax | 20-40 | 28-35 |
| Synthetic wax | 5-30 | 10-18 |
| Ozokerite wax | 1-20 | 5-10 |
| Polymer modified wax | 1-10 | 3-6 |
| Polymer resin | 1-30 | 10-20 |
| Mineral oil | 10-30 | 15-20 |
| Talc powders | 1-20 | 5-15 |
| Microspheres | 1-10 | 1-5 |
| Pigment | 0.1-20 | 0.2-16 |
| Preservative | 0.02-0.2 | 0.08-0.13 |

Table 2 shows the modeling composition which consists of Microcrystalline wax (20-40 wt %), Synthetic wax (5-30 wt %), Ozokerite wax (1-20 wt %), Polymer modified wax (1-10 wt %) and polymer resin (1-30 wt %), oil (10-30 wt %), filler such as Talc powders (1-20 wt %) and microspheres (1-10 wt %) as well as various pigments and preservatives. In one embodiment, the preferred range is Microcrystalline wax (28-35 wt %), Synthetic wax (10-18 wt %), Ozokerite wax (5-10 wt %), Polymer modified wax (3-6 wt %) and polymer resin (10-20 wt %), oil (15-20 wt %), filler such as Talc powders (5-15 wt %) and microspheres (1-5 wt %). The polymer resin is polyurethane or polysiloxane or elastomers. The pigments and preservatives are the same as those in example 1.

### Example 3

TABLE 3

| | Percentage | Perfected |
|---|---|---|
| Ingredient | range by weight % | range by weight % |
| Microcrystalline wax | 20-50 | 30-40 |
| Synthetic wax | 5-30 | 10-18 |
| Bee wax | 1-20 | 4-9 |
| Polymer modified wax | 1-10 | 3-6 |
| Polymer resin | 10-30 | 20-25 |
| Mineral oil | 10-30 | 15-20 |
| Microspheres | 1-10 | 2-5 |
| Pigment | 0.1-20 | 0.2-16 |
| Preservative | 0.02-0.2 | 0.08-0.13 |

The modeling composition shown in Table 3 consists of Microcrystalline wax (20-50 wt %), Synthetic wax (5-30 wt %), Bee wax (1-20 wt %), Polymer modified wax (1-10 wt %), polymer resin (10-30 wt %), oil (10-30 wt %), and microspheres (1 -10 wt %) as well as various pigments and preservatives. In one embodiment, the preferred range is Microcrystalline wax (30-40 wt %), Synthetic wax (10-18 wt %), Bee wax (4-9 wt %), Polymer modified wax (3-6 wt %), polymer resin (20-25 wt %), oil (15-20 wt %), and microspheres (2-5 wt %). The polymer resin is polyurethane or polysiloxane or elastomers. The pigments and preservatives are the same as those in example 1.

### Example 4

The modeling composition listed in Table 4 consists of Microcrystalline wax (20-50 wt %), Synthetic wax (5-30 wt %), Elasto/Icing-wax (15-40 wt %), Polymer modified wax (0-10 wt %), oil (5-20 wt %), filler such as Talc powders (10-30 wt %) and microspheres (1-10 wt %) as well as various pigments and preservatives. In one embodiment, the preferred range is Microcrystalline wax (30-40 wt %), Synthetic wax (10-16 wt %), Elasto/Icing-wax (20-30 wt %), Polymer modified wax (0-5 wt %), oil (10-18 wt %), Talc powders (15-20 wt %) and microspheres (2-5 wt %). The pigments and preservatives can be the same as those in example 1.

TABLE 4

| | Percentage | Perfected |
|---|---|---|
| Ingredient | range by weight % | range by weight % |
| Microcrystalline wax | 20-50 | 30-40 |
| Synthetic wax | 5-30 | 10-16 |
| Elasto/Icing wax | 15-40 | 20-30 |
| Polymer modified wax | 0-10 | 0-5 |
| Talc powders | 10-30 | 15-20 |
| Mineral oil | 5-20 | 10-18 |
| Microspheres | 1-10 | 2-5 |
| Pigment | 0.1-20 | 0.2-16 |
| Preservative | 0.02-0.2 | 0.08-0.13 |

The above modeling compositions are generally lightweight and tend not to dry out. They also have good handling and reshaping capabilities, which are well liked by children.

### Example 5

Any of the compositions described in Examples 1-4 can be prepared according to the following procedure:

The waxes, such as Microcrystalline wax, Synthetic wax, Ozokerite wax or Bee wax or Elasto/Icing-wax, Polymer modified wax and/or polymer resin, and oil are added to a mixer or a tank. Next, the mixer or tank is heated to 90-120° C., with stirring, until all of waxes have melted. Then, filler such as Talc powders and encapsulated copolymer and colorants are added to the mixer or tank. After the fillers and colorants are added, stop heating but continue mixing until the composition is uniform. Finally, discharge the fully compounded modeling compound from the mixer or tank.

Regarding the above mentioned examples, the modeling compositions presented have a density range of 350-950 KG/m³ and hardness range of 40-140 Pen (c) at room temperature.

While the invention has been described herein with regards to specific examples and embodiments, it should be understood by those skilled in the art that other examples and embodiments are also contemplated.

I claim:

1. A modeling composition comprising:
a solid wax;
oil;
fillers;
0-30 wt. % polymer resin; and
1-10 wt. % microspheres, wherein the microspheres include spherical polymer shells encapsulating a gas.

2. The modeling composition of claim 1 wherein the gas is a hydrocarbon.

3. The modeling composition of claim 1 wherein the solid wax comprises 20-50 wt. % microcrystalline wax, 5-30 wt. % synthetic wax, 1-20 wt. % ozokerite wax and 1-10 wt. % polymer modified wax.

4. The modeling composition of claim 1 wherein the solid wax comprises 20-50 wt. % microcrystalline wax, 5-30 wt. % synthetic wax, 1-20 wt. % bee wax and 1-10 wt. % polymer modified wax.

5. The modeling composition of claim 1 wherein the solid wax comprises 20-50 wt. % microcrystalline wax, 5-30 wt. % synthetic wax, 1-20 wt. % elasto/icing-wax and 1-10 wt. % polymer modified wax.

6. The modeling composition of claim 1 wherein the filler includes talc powder.

7. The modeling composition of claim 6 wherein the talc powder is 300-1000 mesh.

8. The modeling composition of claim 6 wherein the talc powder is 1000-2000 mesh.

9. The modeling composition of claim 6 wherein the talc powder is greater than 2000 mesh.

10. The modeling composition of claim 6 wherein the talc powder is a mixture of 300-1000 mesh, 1000-2000 mesh and above 2000 mesh.

11. The modeling composition of claim 1 further comprising pigments.

12. The modeling composition of claim 1 further comprising preservatives.

13. The modeling composition of claim 12 wherein the preservatives include at least one of methylparaben, propylparaben, ethylparaben, and phenoxyethanol.

14. The modeling composition of claim 1 wherein the microspheres increase in size as the gas is heated.

15. The modeling composition of claim 1 wherein the polymer resin includes at least one of polyurethane, polysiloxane and elastomers.
